(19) United States
(12) Patent Application Publication
(10) Pub. No.: US 2007/0080786 A1
(43) Pub. Date: Apr. 12, 2007

(54) Image forming apparatus

(75) Inventor: Tadaharu Kusumi, Osaka (JP)

Correspondence Address: SMITH, GAMBRELL & RUSSELL, 1850 M STREET, N.W., SUITE 800, WASHINGTON, DC, 20036, US

(73) Assignee: KYOCERA MITA CORPORATION

(21) Appl. No.: 11/528,588

(22) Filed: Sep. 28, 2006

(30) Foreign Application Priority Data
Oct. 6, 2005 (JP) 2005-293501

(51) Int. Cl. H04Q 5/22

(52) U.S. Cl. 340/10.1

(57) ABSTRACT

When, based on a detection signal from a cover opening/closing detection portion 25, a CPU 20 recognizes that a cover is open, that is, a switch 61 is in an OFF state, the CPU 20 forbids wireless communication between a first transmitter-receiver 26 and a wireless tag 30. By contrast, when, based on the detection signal from the cover opening/closing detection portion 25, the CPU 20 recognizes that the cover is closed, that is, the switch 61 is in an ON state, the CPU 20 permits wireless communication between the first transmitter-receiver and the wireless tag 30.

This application is based on Japanese Patent Application No. 2005-293501 filed on Oct. 6, 2005, the contents of which are hereby incorporated by reference.

### BACKGROUND OF THE INVENTION

1. Field of the Invention

The present invention relates to an image forming apparatus such as a copier and a printer, and in particular to an image forming apparatus that reduces leakage of unnecessary electromagnetic noise emitted from an RFID (Radio Frequency Identification) system incorporated therein.

2. Description of Related Art

Electromagnetic noise emitted from an electronic device adversely affects other electronic devices. Hence its emission is restricted by various standards (for example, those formulated by the Special International Committee on Radio Interference, with a French acronym “CISPR”). On the other hand, image forming apparatuses commonly incorporate an RFID system complying with such standards directed to electromagnetic noise.

An RFID system is composed of a reader/writer module (hereinafter referred to as R/W module) and a wireless tag. Typically, an R/W module is fitted to the main body of an image forming apparatus. A wireless tag has a memory and is fitted to a replacement part of the image forming apparatus, for example, a consumable component such as a cartridge and a toner container.

To write data to the memory of the wireless tag, the R/W module generates electromagnetic waves containing a write instruction and data. The wireless tag is activated on receiving the electromagnetic waves, and according to the write instruction, the data is written to the memory thereof.

On the other hand, to read data from the memory of the wireless tag, the R/W module generates electromagnetic waves containing a read instruction. Activated on receiving the electromagnetic waves, the wireless tag transmits the data stored in the memory to the R/W module according to the read instruction. Operating in this way, an RFID system can be used for the management of replacement parts, for example, for the management of the models, part numbers, etc of replacement parts.

In the image forming apparatus structured as described above, shielding is achieved with a conductive member that encloses the R/W module and the wireless tag from around them. Since the wireless tag is fitted to a replacement part, shielding is applied to the inner face of a cover that is provided on the exterior of the image forming apparatus and that is opened for replacement of a replacement part. This reduces the emission of the electromagnetic noise generated by the R/W module out of the apparatus and thereby helps comply with the CISPR or other standards.

JP-A-2004-341836 discloses a host apparatus, such as an image forming apparatus that has a wireless tag fitted to a component thereof such as a consumable component. This host apparatus reads, via an R/W module, a component identification signal or component information to check whether or not the component complies with the genuine standards required by the host apparatus. This makes it possible to easily prevent an illegally imitated component from being used.

Also, JP-A-2005-81720 discloses an image forming apparatus that has a wireless tag fitted to a consumable-material container such as an ink cartridge. This image forming apparatus detects incomplete fitting of the consumable-material container based on the communication state between an R/W module fitted to the main body thereof and the wireless tag.

When a cover provided on an image forming apparatus is opened for replacement of a replacement part, however, the inside of the image forming apparatus becomes open to the outside. In this state, if wireless communication is performed between an R/W module and a wireless tag, the electromagnetic noise generated by the R/W module is emitted out of the image forming apparatus. Hence, with a cover open, even though a shielding is applied to the inner face of the cover, it does not offer a sufficient shielding effect to prevent adverse effects on the surrounding environment.

### SUMMARY OF THE INVENTION

An object of the present invention is to provide an image forming apparatus that surely prevents the emission of electromagnetic noise out of it.

To achieve the above object, an image forming apparatus is provided with: a replacement part that is detachable and that has a wireless tag fitted thereto; a transmitter-receiver that performs communication with the wireless tag; a cover that is openably attached to the main body to permit replacement of the replacement part and to which shielding is applied; and a cover opening/closing detection portion for detecting whether the cover is open or closed. Here, when the cover is in an open state, communication between the wireless tag and the transmitter-receiver is forbidden, and when the cover is in a closed state, communication between the wireless tag and the transmitter-receiver is permitted.

With this structure, when the cover is open, communication between the wireless tag and the transmitter-receiver is forbidden to thereby prevent the transmitter-receiver from generating electromagnetic noise. This surely prevents the emission of electromagnetic noise out of the apparatus.

### BRIEF DESCRIPTION OF THE DRAWINGS

FIG. 1 is a perspective view showing the whole structure of an image forming apparatus embodying the present invention;

FIG. 2 is a block diagram showing the structure of the image forming apparatus embodying the present invention;

FIG. 3 is a diagram showing the inner structure of the image forming apparatus embodying the present invention;

FIG. 4 is a perspective view showing a principal part of the image forming apparatus embodying the present invention; and

FIG. 5 is a flow chart illustrating how the image forming apparatus embodying the present invention operates.

### DETAILED DESCRIPTION OF PREFERRED EMBODIMENTS

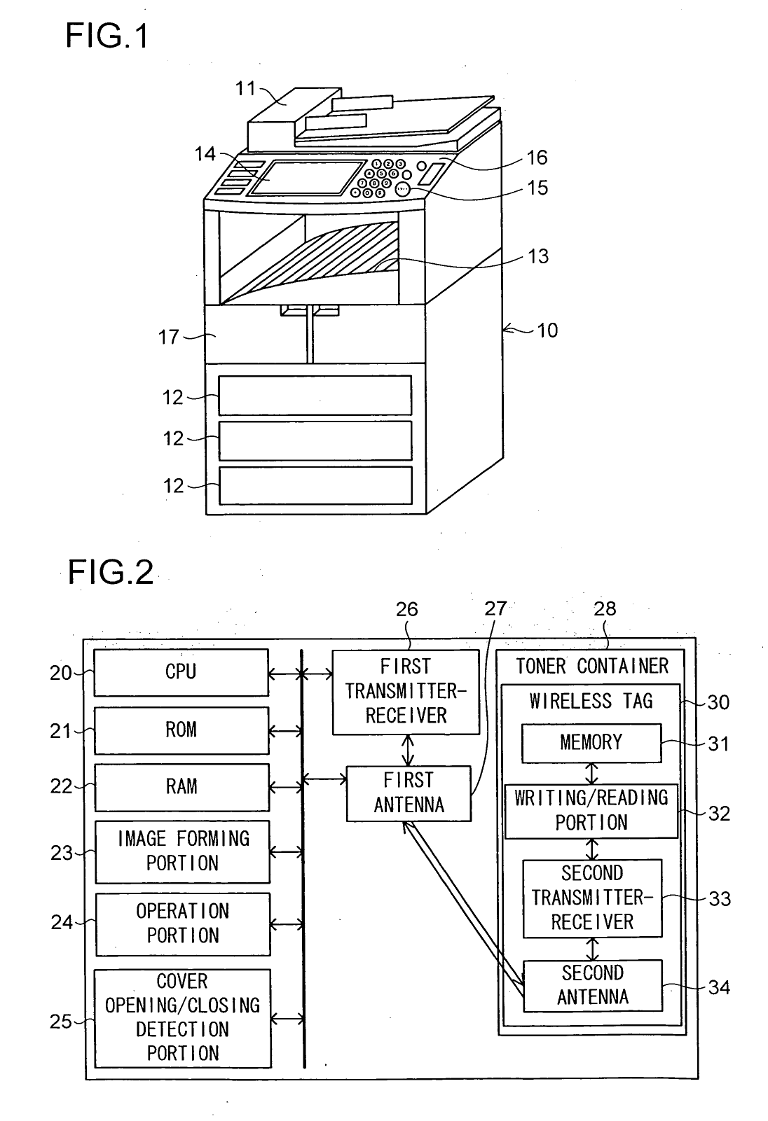

Hereinafter, embodiments of the present invention will be described with reference to the accompanying drawings. FIG. 1 is a perspective view showing the whole structure of an image forming apparatus of the embodiment. The image forming apparatus 10 has a function of copying original documents, and hence is used as a copier. The image forming apparatus 10 is provided with an automatic document feeder (ADF) 11, paper feed cassettes 12, a paper ejection tray 13, and an operation panel 16.

The automatic document feeder 11 transports an original document to have the image data thereof scanned. Paper feed cassettes 12 are provided in plurality to accommodate differently sized sheets (for example, A4 and A3) of recording paper on which to print the image data read from the original document. The paper ejection tray 13 stacks the sheets of recording paper fed from the paper feed cassettes 12, then having image data printed thereon, and then ejected out of the apparatus.

The operation panel 16 is provided with a display screen 14 and a start button 15. The display screen 14 is built as a touch panel, which the user operates to set image forming conditions. The start button 15 is operated when the user starts an image forming operation by using the copying function. On the front face of the image forming apparatus 10 (the face at which the paper feed cassettes 12 are detached), a cover 17 is attached that is composed of two parts arranged horizontally side by side.

FIG. 2 is a block diagram showing the structure of the image forming apparatus 10. The image forming apparatus 10 is provided with a CPU (central processing unit) 20, a ROM (read only memory) 21, RAM (random access memory) 22, an image forming portion 23, an operation portion 24, a cover opening/closing detection portion 25, a first transmitter-receiver 26, and a first antenna 27.

The CPU 20 controls the operation of the whole image forming apparatus 10. The ROM 21 stores various control programs, various kinds of data, etc. The RAM 22 is used as a work area when the CPU 20 performs various kinds of control. The image forming portion 23 prints image data on recording paper. The operation portion 24 performs operations for setting copying conditions and for starting the image forming apparatus 10 via the operation panel 16.

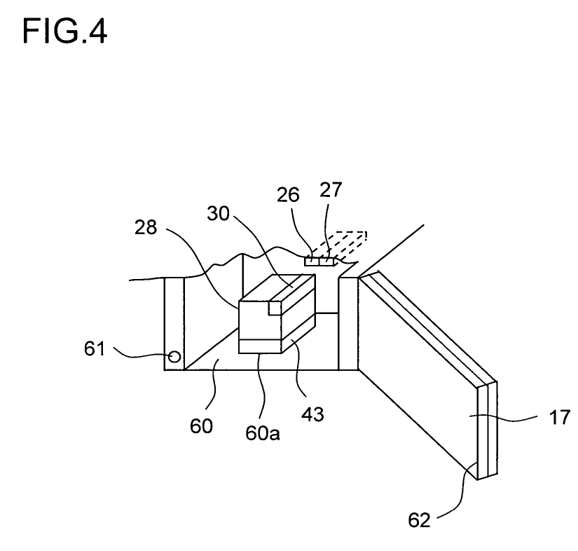

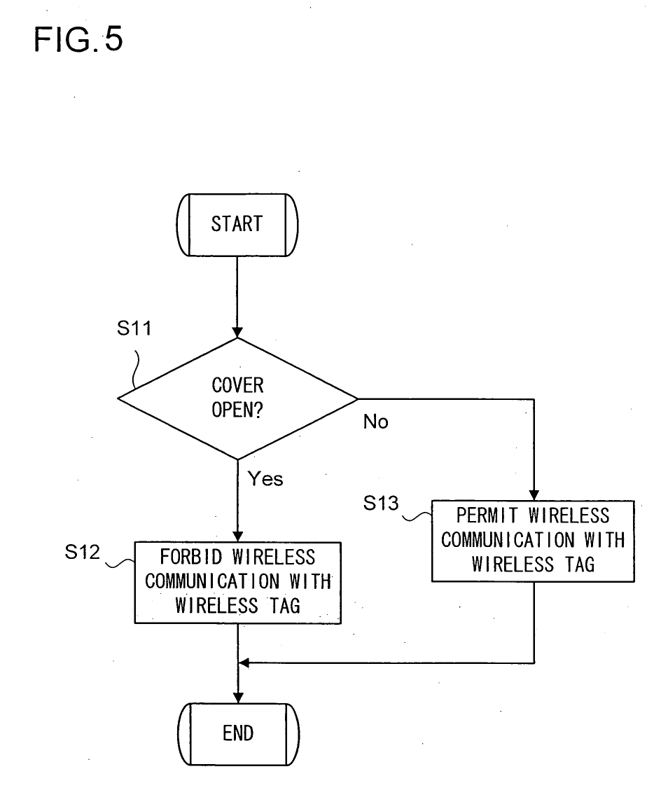

The cover opening/closing detection portion 25 detects the ON/OFF state of a switch 61 (see FIG. 4) fitted on the main body side of the image forming apparatus 10. Specifically, when the cover 17 is closed, the switch 61 is pressed down to be turned ON. And the cover opening/closing detection portion 25 sends to the CPU 20 a detection signal indicating that the cover 17 is closed. On the other hand, when the cover 17 is opened, the switch 61 is turned OFF, and the cover opening/closing detection portion 25 sends to the CPU 20 a detection signal indicating that the cover 17 is open.

The first transmitter-receiver 26 and the first antenna 27 constitute an R/W module of an RFID system. The first transmitter-receiver 26 performs RFID wireless communication with a wireless tag 30 (described later). The first antenna 27 radiates the transmission output of the first transmitter-receiver 26 as electromagnetic waves and also receives the electromagnetic waves emitted from the wireless tag 30 to feed them to the first transmitter-receiver 26 as reception signals.

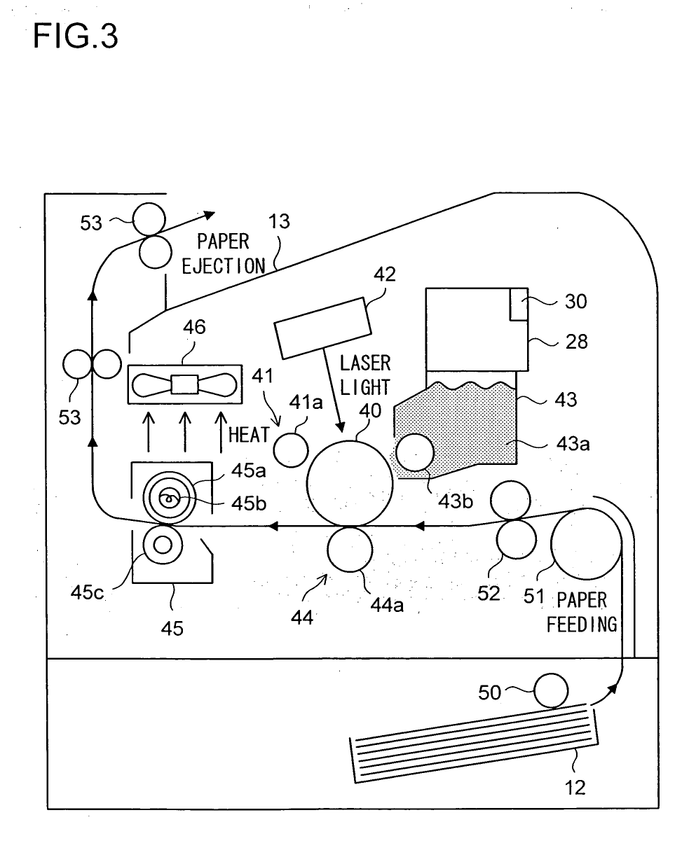

The image forming apparatus 10 is provided with a toner container 28. The toner container 28 is a replacement part detachable from an image forming unit 43 (see FIG. 3) via the cover 17 and accommodates toner 43a that is supplied to the image forming unit 43. Also, the wireless tag 30 is fitted to the toner container 28.

The wireless tag 30 is provided with a memory 31, a writing/reading portion 32, a second transmitter-receiver 33 and a second antenna 34, and performs RFID wireless communication with the R/W module. The memory 31 is a nonvolatile memory for storing data fed from the first transmitter-receiver 26 via the first antenna 27. The writing/reading portion 32 writes data to the memory 31 according to a write instruction from the first transmitter-receiver 26 and also reads data from the memory 31 according to a read instruction from the first transmitter-receiver 26.

The second transmitter-receiver 33 performs RFID wireless communication with the first transmitter-receiver 26 via the first antenna 27 and the second antenna 34. The second antenna 34 receives the electromagnetic waves radiated from the first antenna 27 to feed them to the second transmitter-receiver 33 as a reception signal and also emits the electromagnetic waves outputted from the second transmitter-receiver 33 as an output signal. The second transmitter-receiver 33 is further provided with a power generation portion (not shown) that uses an electromagnetic wave received by the second antenna 34 to generate power. The provision of the power generation portion permits the wireless tag 30 to operate. Instead of the power generation portion, a power source such as a battery may be provided.

FIG. 3 is a diagram showing the inner structure of the image forming apparatus 10. The image forming portion 23 (see FIG. 2) that is provided inside the image forming apparatus 10 is provided with a photoconductive drum 40, a charger 41, an exposure device 42, a development device 43, a transfer device 44, a fixing device 45, and a cooling fan 46.

The charger 41 is provided with a charging roller 41a disposed near the photoconductive drum 40 and permits the surface of the photoconductive drum 40 to be negatively charged by the electric discharge of the charging roller 41a. The exposure device 42 is provided with a laser scanner (not shown) and makes the laser scanner irradiate the photoconductive drum 40 with laser light to permit the part of the photoconductive drum 40 that receives the laser light to be positively charged. Thus, an electrostatic latent image is formed on the part of the photoconductive drum 40 that is irradiated with laser light.

The development device 43 is disposed near the photoconductive drum 40, accommodates the toner 43a, and is provided with a development roller 43b for supplying the toner 43a to the photoconductive drum 40. Also, the development device 43 makes the toner 43a adhere to the electrostatic latent image formed on the surface of the photoconductive drum 40 to perform development. Incidentally, the toner container 28 is fitted on the top of the development device 43 and supplies the toner 43a to the development device 43.

The transfer device 44 is provided with a transfer roller 44a, and the transfer roller 44a and the photoconductive drum 40 are kept in contact with each other so as to form a nip portion therebetween that nips recording paper. When recording paper passes through the nip portion between the transfer roller 44a and the photoconductive drum 40, the positively charged transfer roller 44a attracts the toner 43a that has been adhered to the photoconductive drum 40. Thus, the transfer device 44 transfers the toner 43a onto the recording paper.

The fixing device 45 is provided with a fixing roller 45a and a press roller 45c that face each other so as to be kept in contact with each other to form a nip portion therebetween that nips recording paper. Inside the fixing roller 45a is provided a fixing heater 45b for heating the fixing roller 45a. While the recording paper is passing through the nip portion between the fixing roller 45a and the press roller 45c, the toner 43a that has been transferred onto the paper is fused by the heat from the fixing roller 45a. Simultaneously, the press roller 45c presses the recording paper. Thus, the fixing device 45 fixes the toner 43a on the recording paper.

The cooling fan 46 dissipates the heat generated in the fixing device 45 out of the image forming apparatus 10 to cool down the inside thereof.

The image forming apparatus 10 is further provided with, inside it, a paper feed roller 50, a transport roller 51, a pair of resist rollers 52, and paper ejection rollers 53. The paper feed roller 50 feeds recording paper out of the paper feed cassettes 12. The transport roller 51 transports the recording paper fed from the paper feed roller 50. The resist rollers 52 adjust the orientation of the recording paper that has passed through the transport roller 51 and also controls the timing for starting the transport of the recording paper. The paper ejection rollers 53 eject onto the paper ejection tray 13 the recording paper that has passed through the photoconductive drum 40 and the fixing device 45. Incidentally, in FIG. 3, just one of the plurality of paper feed cassettes is illustrated.

FIG. 4 is a perspective view of the image forming apparatus 10 with the right-hand part of the cover 17 open. When the cover 17 is open, there is exposed a housing portion 60 formed for accommodating the toner container 28. On the bottom face of the housing portion 60, an opening 60a is formed, and through the opening 60a, with a small gap left therefrom, the upper portion of the development device 43 protrudes.

The toner container 28 is detachably fitted on the top of the development device 43 and is replaceable by the opening/closing of the cover 17. Specifically, when the toner 43a (see FIG. 3) accommodated in the toner container 28 is used up, the display screen 14 displays accordingly. Then, the user opens the cover 17 in order to replace the toner container 28 with a new toner container 28 with toner 43a accommodated therein. In this state, the old toner container 28 is detached from the development device 43, a new toner container 28 is attached to the development device 43, and then the user closes the cover 17.

On the top face of the housing portion 60, the first transmitter 26 and the first antenna 27 are arranged so as to face the wireless tag 30 fitted to an edge portion of the toner container 28. This makes it possible to easily achieve communication between the R/W module and the wireless tag 30.

Shielding is also applied, with a conductive member 62, to the inner wall of the housing portion 60 and the back face of the cover 17 (the face thereof facing inward of the image forming apparatus 10). This prevents electromagnetic noise generated by the first transmitter-receiver 26 from being emitted out of the apparatus. Instead, a conductive coating 62 may be applied to the front face of the cover 17 (the face thereof facing outward of the image forming apparatus) to achieve shielding. Incidentally, the cover 17 may be fitted not only to the front face of the image forming apparatus 10 but also to the back face thereof, i.e. the face located opposite to the front face, or to one of the side faces thereof, i.e. one perpendicular to the front face, or to the top face thereof.

In the image forming apparatus 10 structured as described above, to copy an original document, the original document is set on an automatic document feeder 11. The user sets image forming conditions via the display screen 14 of the operation panel 16. When the start button 15 on the operation panel 16 is pressed, information according to the user's instruction is fed from the operation portion 24 to the CPU 20. The CPU 20, after recognizing that a print start instruction has been fed in, instructs the automatic document feeder 11 to feed the original document so that the image data thereof is scanned. The scanned image data is fed to the image forming portion 23.

As indicated by the solid line arrow in FIG. 3, the paper feed roller 50 feeds recording paper out of one of the paper feed cassettes 12. The recording paper fed out of the paper feed cassette 12 is then transported to the transport roller 51. The recording paper that has passed through the transport roller 51 has the orientation thereof adjusted and the timing for starting the transport thereof controlled by the pair of resist rollers 52 so as to be transported to the nip portion formed between the photoconductive drum 40 and the transfer roller 44a.

While the recording paper is being transported toward the photoconductive drum 40, the charging processing is performed in which the charger 41 charges the whole surface of the photoconductive drum 40. Subsequently, the exposure processing is performed in which the exposure device 42 irradiates the photoconductive drum 40 with laser light so as to form an electrostatic latent image. Subsequently, the development processing is performed in which the development device 43 makes the toner 43a adhere to the electrostatic latent image.

Subsequently, the transfer processing is performed in which the transfer device 44 transfers the toner 43a onto the recording paper passing through the nip portion formed between the photoconductive drum 40 and the transfer roller 44a. The recording paper onto which the toner 43a has been transferred is then transported to the nip portion formed between the fixing roller 45a and the press roller 45c of the fixing device 45. Subsequently, the fixing processing is performed in which the fixing device 45 fixes the toner 43a onto the recording paper having the toner 43a thereon passing through the nip portion formed between the fixing roller 45a and the press roller 45c. The recording paper having the toner 43a fixed thereon is ejected by the paper ejection rollers 53 onto the paper ejection tray 13.

Also, communication is performed between the R/W module, which is composed of the first transmitter-receiver 26 and the first antenna 27, and the wireless tag 30, and thereby the information of the toner container 28 is read and written. In this way, the model, the part number, the replacement timing, and the like of the toner container 28 are managed.

FIG. 5 is a flow chart illustrating how the communication is controlled meanwhile. First, in step S11, the CPU 20 finds whether or not the cover 17 is in an open state based on a detection signal fed from the cover opening/closing detection portion 25. When the switch 61 of the cover 17 is in an OFF state and the CPU 20 recognizes the cover 17 to be open, the processing proceeds to step S12. In step S12, the CPU 20 forbids wireless communication between the first transmitter-receiver 26 and the wireless tag 30, and the processing ends.

When the switch 61 of the cover 17 is in an ON state and the CPU 20 recognizes the cover 17 to be closed, the processing proceeds to step S13. In step S13, the CPU 20 permits communication between the first transmitter-receiver 26 and the wireless tag 30.

When data to be written to the wireless tag 30 and a write instruction to write the data thereto are fed from the CPU 20 to the first transmitter-receiver 26, it converts the data and the write instruction into an RFID output signal. Then, the first transmitter-receiver 26 makes the first antenna 27 radiate electromagnetic waves containing the write instruction and the data.

On the other hand, when a read instruction to read data from the wireless tag 30 is fed from the CPU 20 to the first transmitter-receiver 26, the first transmitter-receiver 26 converts the read instruction into an RFID transmission signal. The first transmitter-receiver 26 then makes the first antenna 27 radiate electromagnetic waves containing the read instruction.

The second transmitter-receiver 33 receives an RFID reception signal (a write instruction, data, a read instruction, or the like) via the second antenna 34, and converts it into a reception signal that can be dealt with by the writing/reading portion 32. Also, the second transmitter-receiver 33 converts the data of the memory 31 fed from the writing/reading portion 32 into an RFID output signal, and makes the second antenna 34 emit it as electromagnetic waves. In this way, wireless communication is performed between the first transmitter-receiver 26 and the wireless tag 30, and information is written to the memory 31 of the wireless tag 30.

According to this embodiment, when the CPU 20 recognizes that the cover is in an open state based on a detection signal from the cover opening/closing detection portion 25, communication between the wireless tag 30 and the first transmitter-receiver 26 is prohibited, and hence emission of electromagnetic waves out of the apparatus can surely be prevented.

The image forming apparatus 10 of this embodiment is provided with a single toner container 28 to perform monochrome printing, but it may be provide with a plurality of toner containers 28 to perform color printing. In this case, a plurality of wireless tags 30 are fitted one to each of the plurality of toner containers 28.

In the embodiment described above, it is assumed that a toner container 28 is fitted with a wireless tag 30; in practice, any other replacement part that is detachable from the main body of an apparatus may be fitted with a wireless tag. Also, it is assumed that wireless communication is performed using an RFID system; in practice, the present invention is widely applicable with any other wireless communication standards. Also, it is assumed that the image forming apparatus 10 is a copier having a copying function; in practice, the image forming apparatus 10 may have any of a scanning function, a printing function, and a facsimile function.

The present invention is applicable to image forming apparatuses such as copiers and printers in which communication is performed using an RFID system or the like between the main body of the apparatus and a wireless tag.

### LIST OF REFERENCE NUMERALS

10 image forming apparatus
11 automatic document feeder
12 paper feed cassette
13 paper ejection tray
14 display screen
15 start button
16 operation panel
17 cover
20 CPU
21 ROM
22 RAM
23 image forming portion
24 operation portion
25 cover opening/closing detection portion
26 first transmitter-receiver
27 first antenna
28 toner container
30 wireless tag
31 memory
32 writing/reading portion
33 second transmitter-receiver
34 second antenna
40 photoconductive drum
41 charger
42 exposure device
43 development device
44 transfer device
45 fixing device
46 cooling fan
60 housing portion
61 switch

What is claimed is:

1. An image forming apparatus, comprising:
a replacement part that is detachable and that has a wireless tag fitted thereto;
a transmitter-receiver that performs communication with the wireless tag;
a cover that is openably attached to the main body to permit replacement of the replacement part and to which shielding is applied; and
a cover opening/closing detection portion for detecting whether the cover is open or closed,
wherein
when the cover is in an open state, communication between the wireless tag and the transmitter-receiver is forbidden, and when the cover is in a closed state, communication between the wireless tag and the transmitter-receiver is permitted.

2. The image forming apparatus of claim 1, wherein a conductive member is provided on an inner face of the cover.

3. The image forming apparatus of claim 1, further comprising:
a housing portion that is opened and closed with the cover and to and from which the replacement part is attached and detached,
wherein shielding is applied to an inner wall of the housing portion.

4. The image forming apparatus of claim 3,
wherein the transmitter-receiver is provided on a wall face of the housing portion, the transmitter-receiver being positioned so as to face the wireless tag.
